(19) United States
(12) Patent Application Publication
(10) Pub. No.: US 2020/0010786 A1
(43) Pub. Date: Jan. 9, 2020

(54) ENHANCED ALCOHOLIC BEVERAGE COMPOSITIONS COMPRISING CANNABIS DERIVATIVES AND ENHANCING METHODS

(71) Applicants: Mark DeCaro, Millstone Township, NJ (US); Guobao Wei, Milltown, NJ (US)

(72) Inventors: Mark DeCaro, Millstone Township, NJ (US); Guobao Wei, Milltown, NJ (US)

(73) Assignees: Mark Decaro, Millstone Township, NJ (US); Dr. Guobao Wei, Milltown, NJ (US)

(21) Appl. No.: 16/557,227

(22) Filed: Aug. 30, 2019

(51) Int. Cl. C12G 3/08; C12G 3/07; C12G 3/026; C12H 1/22; A23L 33/105

(52) U.S. Cl. CPC C12G 3/08; C12G 3/07; A23L 33/105; C12H 1/22; C12G 3/026

(57) ABSTRACT

Enhanced alcoholic beverage compositions and enhancing methods are disclosed. In particular, the invention relates to an enhanced alcoholic beverage composition comprising at least one or more cannabis plant derived compounds, with or without oak wood derived compounds, wherein the cannabis plant derived compounds in the alcoholic beverage composition have a weight ratio of 0.00005% to 5% (w/v %) and the oak wood derived compounds have a weight ratio of 0-5%. The cannabis plant derived compounds include at least one or more cannabinoids including Δ⁹-tetrahydrocannabinol (THC) and cannabidiol (CBD) and at least one or more terpenes. The enhancing methods comprising infusing cannabis plant and/or oak wood derived compounds with alcoholic beverage in presence of subcritical/critical/supercritical carbon dioxide.

### FIELD OF THE INVENTION

The present invention relates to alcoholic beverage compositions enhanced with cannabis derivatives and the enhancing methods. More specifically, the invention relates to a subcritical/critical/supercritical carbon dioxide (CO₂) process for the enhancement of alcoholic beverage compositions using cannabis plant materials or combined cannabis plant and oak wood materials,

### BACKGROUND

The cannabis plant is a complex plant containing more than 400 distinct chemical entities, of which more than 60 are cannabinoid compounds [Ethan B Russo, Cannabis and Cannabinoids: Pharmacology, Toxicology, and Therapeutic Potential, 1^{st} Edition 2002]. Δ⁹-Tetrahydrocannabinol (THC) is the cannabinoid most known for its psychoactive properties while Cannabidiol (CBD), known as lacking the psychoactive effect that Δ⁹-Tetrahydrocannabinol (THC) has, was shown to be clinically useful to reduce inflammation, alleviate nausea and emesis, treat epilepsy, anxiety disorders, or glaucoma. It was also shown to actually counteract the psychoactivity of THC and thus reduce some of the side effects of THC if the THC/CBD ratio is properly adjusted [Scott et al., The Combination of Cannabidiol and Δ9-Tetrahydrocannabinol Enhances the Anticancer Effects of Radiation in an Orthotopic Murine Glioma Model. Molecular Cancer Therapeutics, 2014, 13(12): 2955-2967]. Various studies have also demonstrated that CBD can attenuate binge alcohol-induced neurodegeneration [Daniel J. Liputa, et al., Transdermal Delivery of Cannabidiol Attenuates Binge Alcohol-induced Neurodegeneration in a Rodent Model of an Alcohol Use Disorder, Pharmacology Biochemistry and Behavior, 2013, 111:120-127]. Besides the cannabinoids, terpenes are the organic hydrocarbons responsible for the aroma and flavor of cannabis derived materials and products. There have been more than 100 terpenes found in different cannabis strains, Terpenes from cannabis plants are valuable as they are not only responsible for a given strain's aroma and flavor profiles but also are rich in their own medicinal effects although they are non-psychoactive themselves. In addition, terpenes are found to exponentially increase the effectiveness of THC and CBD molecules which is referred as the “entourage effect” [Ethan B Russo, Taming THC: Potential cannabis synergy and phytocannabinoid-terpenoid entourage effects. British Journal of Pharmacology, 2011 163: 1344-1364]. Different combinations of cannabinoids and terpenes alter the way the brain responds to produce unique effects.

In cannabis plant, cannabinoids are synthesized and accumulated as cannabinoid acids. When the cannabis plant material is dried and heated, the acids decarboxylate gradually into their proper active forms, such as CBD or Δ⁹-THC [De Meijer et al., The Inheritance of Chemical Phenotype in Cannabis sativa L. Genetics, 2003, 163(1): 335-346]. The heating conditions including temperature, pressure, and time etc. impact the activation of THC and CBD and the respective terpene profiles.

Thanks to the medicinal and recreational effect of cannabis plant derived compounds such as THC and CBD and the versatile aroma profiles from cannabis terpenes, there has been increased interest in utilizing those compounds through various delivery vehicles. Especially there are needs of infusing those cannabis derived compounds into consumable alcoholic drinks such as distilled spirit, wine and beer. However, there are unique and dynamic challenges that come along with developing sustainable cannabis infused alcoholic beverages. U.S. Pat. Nos. 9,642,884 and 10,085,965 disclosed a cannabinoid alcoholic drink and the producing method. It used a small amount of ethanol (high alcohol percentage) to fully dissolve cannabinoid or CBD and then combined with consumable alcohols such as vodka to yield the cannabinoid/vodka or cannabidiol/vodka drink. US patent application US2019017767 also disclosed a similar method to produce cannabinoid enriched alcohol beverage by combining cannabinoid oil/ethanol emulsion or suspension with distilled spirit. These methods add pure ethanol to the consumable alcoholic drink thus significantly alters the original drink compositions and are not ideal.

US Pat. Appl. 20120124704 disclosed a method of infusing cannabis by direct soaking the cannabis matter in a consumable alcoholic drink. This method is easy to be utilized at home by individuals. However, the extraction of active cannabis compounds CBD and THC by consumable alcoholic beverages with alcohol concentration between 20% and 55% is too low to achieve their expected medicinal effects and the process itself is not efficient.

Therefore, there is a need for an enhanced alcoholic beverage composition comprising cannabis plant derived active agents. In addition, for some alcoholic beverages such as distilled spirits (tequila, whisky etc.), they are consumed after aged for improved quality complexities such as appearance, smell, taste and other quality complexities imparted by the substance from the aging materials, a lot time the wood barrel. There is also a need for an enhanced alcoholic beverage composition comprising both cannabis plant derived active agents and aging material derived complexities and providing methods of making such compositions.

### BRIEF SUMMARY OF THE INVENTION

It is an objective of the present invention to provide an alcoholic beverage composition enhanced with cannabis plant derived compounds. In some embodiments, the enhanced alcoholic beverage contains a mixture of cannabidiol (CBD) and/or Δ⁹-tetrahydrocannabinol (THC) and terpenes derived from cannabis plant materials in a ratio of 0.00005%-5% (w/v %), preferably in a ratio of 0.005%-0.5% (w/v %). The resulting enhanced alcoholic beverage composition has clear light golden color with aroma profile from terpenes derived from cannabis.

It is another objective to provide an alcoholic beverage composition enhanced with both cannabis plant and oak wood derived compounds. In some embodiments, the enhanced alcoholic beverage contains cannabidiol (CBD) and/or Δ⁹-tetrahydrocannabinol (THC) and terpenes derived from cannabis plant materials and aroma compounds from oak wood in a ratio of 0.00005%-5% (w/v %), preferably in a ratio of 0.005%-0.5% (w/v %). The resulting enhanced alcoholic beverage composition has clear golden color with aroma and flavor profiles derived both from cannabis terpenes and oak wood compounds. The oak wood aroma and flavor compounds include but not limited to at least one of vanillin, oak lactone, furfural/methylfurfural, eugenol/isoeugenol, guaiacol/methylguaiacol, etc.

It is a further objective to provide a method for enhancing alcoholic beverage compositions via an in-situ subcritical/critical/supercritical CO₂ infusion process. In some embodiments, the cannabis plant materials are soaked with alcoholic beverages in the presence of subcritical/critical/supercritical carbon dioxide fluid. In some other embodiments, both cannabis plant and oak wood materials are soaked with alcoholic beverages in the presence of subcritical/critical/supercritical carbon dioxide fluid. After completion of infusion process, carbon dioxide is released to obtain various enhanced alcoholic beverage compositions.

In various embodiments, the cannabis plant materials comprising the buds, flowering tops (flowers), leaves, stalks, seeds or any other portion of a cannabis plant include but not limit to a Cannabis sativa or a Cannabis indica plant.

In various embodiments, the cannabis plant derived compound is at least one of cannabinoid forms comprising Δ⁹-tetrahydrocarmabinol (THC), cannabidiol (CBD), Δ⁸-tetrahydrocannabinol (Δ⁸-THC), cannabichromene (CBC), cannabigerol (CBG), cannabicyclol (CBL), cannabielsoin (CBE), cannbinidiol (CBND), cannabinol (CBN), and cannabitriol (CBT) and at least one of the terpenes comprising myrcene, pinene, linalool, carene, caryophyllene, nerol, geraniol, limonene, terpinolene, valencene, and humulene.

In various embodiments the alcoholic beverage composition is enhanced from an alcoholic beverage comprising at least one of bourbon, whiskey, tequila, gin, brandy, scotch, vodka, rum, wine, and beer.

In various embodiments, the alcoholic beverage composition is enhanced from an aged alcoholic beverage. Aged alcoholic beverages can be obtained by aging the alcoholic beverage through a traditional barrel aging process for 2 months, 1 year, 2 years, 3 years, 5 years, 8 years, 10 years, 15 years, 20 years and 30 years or other accelerated aging methods.

### BRIEF DESCRIPTION OF THE DRAWINGS

FIG. 1 illustrates a flow chart of enhancing alcoholic beverage compositions with cannabis plant derived compounds in an in-situ subcritical/critical/supercritical CO₂ infusing process.

FIG. 2 illustrates a flow chart of enhancing alcoholic beverage compositions with both cannabis plant and oak wood derived compounds in an in-situ subcritical/critical/supercritical CO₂ infusing process.

FIG. 3 shows various tequila samples. Control 1, Plata tequila purchased from a liquor store; Comp A, enhanced tequila composition infused with cannabis plant derived compounds; Comp B, enhanced tequila composition infused with both cannabis plant and oak wood derived compounds; Control 2, enhanced tequila composition infused with oak wood derived compounds; and Control 3, Reposado Tequila (minimum 2 months oak barrel aged) from the same brand as Control 1.

FIG. 4 shows various tequila samples. Control 1, Plata tequila purchased from a liquor store; Comp B, enhanced tequila composition infused with both cannabis plant and oak wood derived compounds at low supercritical CO₂ temperature 55° C.; Comp B, enhanced tequila composition infused with both cannabis plant and oak wood derived compounds at high supercritical CO₂ temperature 95° C.

### DETAILED DESCRIPTION OF THE INVENTION

For the purposes of promoting an understanding of the principles of the disclosure, reference will now be made to certain embodiments and specific language will be used to describe the same. It will nevertheless be understood that no limitation of the scope of the disclosure is thereby intended, such alterations and further modifications in the illustrated methods of aging alcoholic beverages and beverages, and such further applications of the principles of the disclosure as described herein being contemplated as would normally occur to one skilled in the art to which the disclosure relates.

Additionally, unless defined otherwise or apparent from context, all technical and scientific terms used herein have the same meanings as commonly understood by one of ordinary skill in the art to which this disclosure belongs.

For the purposes of this specification and appended claims, unless otherwise indicated, all numbers expressing quantities of ingredients, percentages or proportions of materials, reaction conditions, and other numerical values used in the specification and claims, are to be understood as being modified in all instances by the term “about.” Similarly, when values are expressed as approximations, by use of the antecedent “about,” it will be understood that the particular value forms another embodiment that is +/−10% of the recited value. Accordingly, unless indicated to the contrary, the numerical parameters set forth in the following specification and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. Also, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

Critical carbon dioxide (CO2), as used herein, refers to carbon dioxide at a temperature and pressure reached its thermodynamic critical point at temperature of 31.1° C. and pressure of 1100 psi). Under these conditions, the distinction between gases and liquids does not apply and the CO₂ is described as a fluid. Below its critical point, the CO₂ is subcritical CO₂.

Supercritical carbon dioxide, as used herein, refers to carbon dioxide (CO₂) above its thermodynamic critical point (i.e., above critical temperature of 31.1° C. and pressure of 1100 psi). Under these conditions, the supercritical carbon dioxide has the ability to diffuse through solids like a gas, and dissolve materials like a liquid. Additionally, a supercritical carbon dioxide can readily change in density upon minor changes in temperature or pressure. Supercritical carbon dioxide is an excellent non-polar solvent for many organic compounds. It has been likened to a solvent resembling hexane, though with some hydrogen-bonding acceptor capability and some dipole selectivity. Alkenes, alkanes, aromatics, ketones, and alcohols (up to a relative molecular mass of around 400) dissolve in supercritical carbon dioxide. Very polar molecules such as sugars or amino acids and most inorganic salts are insoluble. By adjusting the pressure of the fluid, the solvent properties can be adjusted to more “gas-like” or more “liquid-like”, which allows tuning of the solvent properties.

New enhanced alcoholic beverage compositions and their enhancing methods and processes are disclosed in this invention. The present application is directed to the use of subcritical/critical/supercritical carbon dioxide (CO₂) in infusing alcoholic beverages with cannabis plant materials or the combination of cannabis plant and oak wood materials. Subcritical/critical/supercritical CO₂ acts as a non-polar solvent, co-acted with alcohols from the alcoholic beverage, to selectively extract a spectrum of compounds from cannabis plant materials and/or oak wood materials. The extracted compounds directly react with alcoholic beverage in situ to result in enhanced alcoholic beverage compositions in a short time period. After infusing with alcoholic beverage, the extracted compounds provide respective medicinal, aroma, and flavor profiles to the alcoholic beverage compositions. At the end of the process, carbon dioxide is removed easily without leaving any unwanted/toxic residues in the enhanced alcoholic beverage compositions. The entire process is carried out in an oxygen free environment which prevents oxidation damages to the compounds and alcoholic beverage at elevated temperature.

The medicinal effects of the resulting enhanced alcoholic beverage compositions are from the compounds derived from cannabis plant materials. The cannabis plant derived compounds with medicinal benefits include but are not limited to Δ⁹-tetrahydrocarmabinol (THC), cannabidiol (CBD), Δ⁸-tetrahydrocannabinol (Δ⁸-THC), cannabichromene (CBC), cannabigerol (CBG), cannabicyclol (CBL), cannabielsoin (CBE), cannbinidiol (CBND), cannabinol (CBN), and cannabitriol (CBT). The aroma and flavor profiles are from terpenes from cannabis plant, the compounds derived from oak wood materials, or the combination of those compounds from both. The terpenes derived from cannabis plant comprises at least one of myrcene, pinene, linalool, carene, caryophyllene, nerol, geraniol, limonene, terpinolene, valencene, and humulene. The aroma and flavor compounds derived from oak wood include but are not limited to tannin, vanillin, lactones, furfural, methylfurfural, eugenol, isoeugenol, guaiacol, methylguaiacol, and ethylphenol.

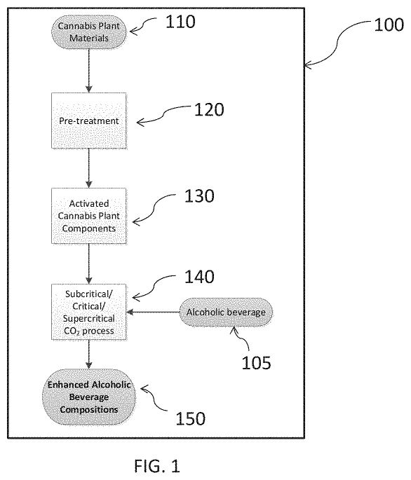

FIG. 1 illustrates a flow diagram of an in-situ enhancing method 100 to obtain enhanced alcoholic beverage compositions 150. The process starts with cannabis plant materials 110 and alcoholic beverage 105. Cannabis plant materials 110 are pre-treated in process step 120 to activate the components in the material. Activated cannabis plant materials 130 are then mixed with alcoholic beverage 105 in a subcritical/critical/supercritical carbon dioxide process 140 to obtain enhanced alcoholic beverage compositions 150.

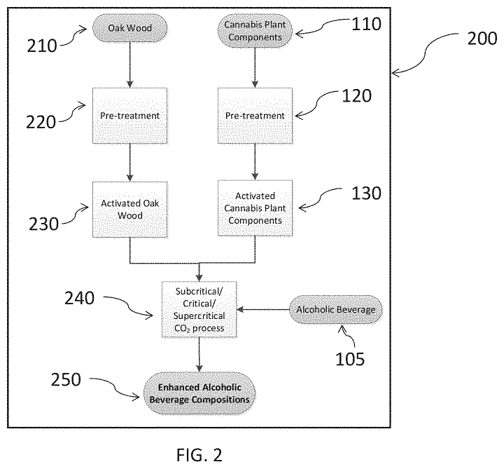

FIG. 2 illustrates a flow diagram of another in-situ enhancing method 200 to obtain enhanced alcoholic beverage compositions 250. The process starts with cannabis plant materials 110, oak wood 210, and alcoholic beverage 105. Cannabis plant materials are pre-treated in process step 120 to activate the components in the material while oak wood materials are treated at step 220 to obtain activated oak wood 230. Activated cannabis plant material 130 and activated oak wood 230 are then mixed with alcoholic beverage 105 in a subcritical/critical/supercritical carbon dioxide process 240 to obtain enhanced alcoholic beverage compositions 250.

In some embodiments, the alcoholic beverage 105 used in methods 100 and 200 include but are not limited to a red wine, a whiskey, a gin, a brandy, a vodka, a tequila, a scotch, a rum, a bourbon, a beer, a rice wine, or a combination of herein. In some other embodiments, the alcoholic beverage 105 can be an aged alcoholic beverage. The aging process can be a traditional barrel aging or some advanced accelerated aging methods. The aged alcoholic beverage can be aged in a barrel for 2 months, 1 year, 2 years, 3 years, 5 years, 8 years, 10 years, 15 years, 20 years and up to 30 years.

Cannabis plant materials 110 are the buds, the flowering tops (flowers), leaves, stalks, seeds or any other portion of a cannabis plant. The cannabis plant has two main subspecies, Cannabis sativa and Cannabis indica, which have a number of different strains respectively with different content profiles for cannabinoids such as CBD, THC and terpenes. Indica-dominant strains have higher content of CBD than the sativa plants which has higher content of THC. In some embodiments, cannabis sativa plant materials are used to achieve enhanced alcoholic beverage compositions with high THC infusion. The resulting enhanced alcoholic beverage composition has given psychoactive response. In some other embodiments, both cannabis sativa and cannabis indica plant materials are used to infuse alcoholic beverage compositions. The resulting enhanced alcoholic beverage compositions have balanced CBD and THC contents to resulted in optimal medicinal effect and psychoactive response. The enhanced alcoholic beverage compositions also offer unique aroma and flavor profiles from different terpenes in cannabis plant strains. The terpenes also provide entourage effects to the psychoactivity of THC or the balanced medicinal effect of CBD and THC. The starting cannabis plant materials can be in fresh (with high moisture concentration) or dried conditions.

Cannabis plant materials 110 in both methods 100 and 200 are pre-treated at step 120 before they are used for infusing with alcoholic beverages. The pre-treatment involves heating cannabis plant materials in an oven. The heating temperature ranged from 100° C., 150° C., 200° C., to 250° C., and 300° C. in a time period from 5, 10, 20, 30, 40, 50, 60 minutes to 2, 3, 4, 5, 6, and 12 hours. The heating activates the cannabis plant materials by de-carboxylating some cannabinoids into their active forms, the activated cannabis plant components 130. In some embodiments, the cannabidiol acid (CBDA) are activated into CBD. In some other embodiments, Δ⁹-tetrahydrocannabinol acid (THCA) are activated into Δ⁹-THC. In addition, the terpenoids are activated into terpenes which can be readily incorporated into alcoholic beverages to provide aroma and flavor profiles. In some embodiment, the pre-treatment is performed in vacuum or in some inert environment to protect the degradation of cannabis plant derived compounds at high temperature.

The subcritical/critical/supercritical CO₂ process 140 is applied to activated cannabis plant materials in presence of alcoholic beverages 105. In some embodiments, the cannabis materials and alcoholic beverages are subjected to subcritical/critical/supercritical carbon dioxide infusion process 140 which is carried out at or above the critical point of CO₂. The critical point for carbon dioxide is 304.25K at 7.39 MPa or 31.1° C. at 1072 psi or 31.1° C. and 73.8 bar. To perform supercritical treatment, the temperature and pressure may continue to be raised, for example to 55-60° C. with corresponding pressure of 85-100 bar. In some other embodiments, the temperature is raised to 90-100° C. with corresponding pressure of 120-200 bar. The infusion duration under critical/supercritical conditions can last from 5 minutes to 6 hours. Different supercritical CO₂ process parameters (pressure, temperature and duration time) provide different infusion profiles to the enhanced alcoholic beverage compositions.

In the enhancing method 200 as shown in FIG. 2, the oak wood material 210 is from white oak, red oak and other oak species. Different oak species have different aroma and flavor compound profiles. The material can be from the heartwood or sapwood of an oak tree in formats of chips, fibers, particles, granules, sticks, slabs and other formats. In various embodiments, the oak wood 210 can be replaced with cherry, hickory, cedar, maple, redwood, palm, chestnut, acacia, apple, alder, pecan, almond, peach, apricot, lemon, birth, beech, plum, walnut, grapefruit, sycamore, or the combination thereof. Also, driftwood from rivers or oceans can be used. Different wood types or combinations present different aroma and flavor profiles to enhance alcoholic beverage compositions. Combinations of various wood materials can be used. In some embodiments, wood materials from historical items such as shipwrecks, ancient buildings, archaeological excavations etc. can be used.

Oak wood materials 210 are pre-treated at step 220 to obtain activated oak wood materials 230. In some embodiments, the pre-treatment involves toast or bake the oak wood 210 in an oven. The toasting or baking process can char the wood fiber/chip surfaces. The toast/bake temperature is ranged from 100° C., 150° C., 200° C., to 250° C., 300° C., 350° C., 400° C., 450° C., 500° C. and 600° C. The toast/bake time is ranged from 5, 10, 20, 30, 40, 50, 60 minutes to 2, 3, 4, 5, 6, 8, 10, 12, 18, 24, 36, 48 and 96 hours. The pre-treatment activates the oak wood aroma and flavor compounds. In some embodiments, the pretreatment can involve a subcritical/critical/supercritical CO₂ process similar to process step 140 as described in FIG. 1.

Activated oak wood 230 present aroma and flavor profiles include but not limit to a flavor of vanilla, buttery, caramel, nutty, clove, toasty, sweet tobacco, charcoal, smoky and the combination thereof.

Activated oak wood 230 and activated cannabis plant material 130 are soaked with alcoholic beverage 105 in the presence of subcritical/critical/supercritical CO₂ at step 240 in the enhancing method 200. At or above the critical point of CO₂ (31.1° C. and 73.8 bar), the cannabinoids (CBD and/or THC) and terpenes in activated cannabis plant materials 130 and the aroma and flavor compounds in activated oak wood materials 230 are selectively extracted from the materials and infused into alcoholic beverage 105 in situ. This results to an enhanced alcoholic beverage composition 250 with both medicinal benefits from cannabis plant and unique aroma/flavor profiles from oak wood and cannabis plant materials. The appearance of enhanced alcoholic beverage composition 250 is silky, creamy, bright, etc. with tastes of clean, woody, smoothness, pepper, spicy, musky, cinnamon, etc.

For supercritical CO₂ treatment, the temperature and pressure may continue to be raised above critical point, for example to 40° C., 50° C., 60° C., 70° C., 80° C., 100° C., 200° C., 300° C., 400° C., 500° C. or 600° C. with corresponding pressure of up to 1000 bar, Due to the presence of CO₂, the activated compounds in cannabis plant and oak wood materials remain their active form without the damage from high temperatures.

The process 240 duration under subcritical/critical/supercritical conditions can last from 1 minute to 30 days, preferably from 1 hour to 24 hours.

The subcritical/critical/supercritical CO₂ process 240 increases the surface areas of the oak wood and subcritical/critical/supercritical CO₂ increases the penetration of CO₂ into oak wood or cannabis materials to extract compounds which cannot be extracted by other methods. The process extracts undamaged and unaltered entities from cannabis plant or oak wood materials in a natural way.

In some embodiments, the subcritical/critical/supercritical CO₂ process 140 or 240 is repeated more than once. When one process cycle is completed, CO₂ gas is released partially or completely, and the contained materials are cooled down. Fresh CO₂ can be introduced and the subcritical/critical/supercritical CO₂ process 140 or 240 can be repeated multiple times with different cycle parameters (different pressure, temperature and duration). Infusing with multiple subcritical/critical/supercritical CO₂ cycles provide higher content of compounds from the materials.

During the enhancing process, the wood/alcoholic beverage and the cannabis material/alcoholic beverage ratios are important for the ultimate quality of enhanced alcoholic beverage compositions and the enhancing processes. Depending on the wood and cannabis type selected and alcoholic beverage used, the wood to alcoholic beverage ratio is ranged from 0.1 g/L, 5 g/L, 10 g/L, 50 g/L, 100 g/L to 500 g/L and the cannabis plant material to alcoholic beverage ratio is ranged from 10 mg/L, 50 mg/L, 100 mg/L, 500 mg/L, 1000 mg/L, 2000 mg/L to 5000 mg/L.

### EXAMPLES

### Example 1 Pre-Treatment of Cannabis Plant Flowers

About 2 g dried cannabis plant material (flowers) was sealed in a foil pouch and placed in an oven at 120° C. for 45 minutes. After completing the heating process, the temperature was reduced to room temperature. Cannabis contained foil pouches were taken out and stored sealed at room temperature. It was not opened until use. After use, the remaining materials should be re-sealed.

### Example 2 Pre-Treatment of Oak Wood

About 20 g fresh oak wood was split into pieces with about 0.8 g per piece. The oak wood pieces were placed into a supercritical CO2 chamber which went through a critical point drying (CPD) process. The temperature and pressure were kept at about 50° C. and 900 psi, respectively for 60 minutes. The total cycle time was about 60 minutes. After that, the pieces were taken out from the chamber and sealed into a foil pouch. It was then heated in an oven to about 200° C. for 90 minutes. The temperature was naturally cooled down to room temperature. Oak wood contained foil pouches were taken out and stored sealed at room temperature. It was not opened until use. After use, the remaining materials should be re-sealed.

### Example 3 Enhanced Tequila with Cannabis Derivatives

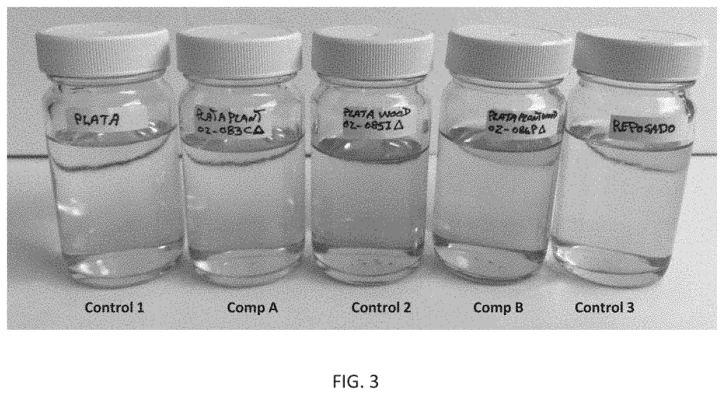

100% agave tequila (Plata, distilled without aging) was obtained from a liquor store. About 0.05 g pre-treated cannabis plant flowers were added to about 50 ml Plata tequila in a supercritical CO2 chamber which went through a supercritical enhancing and infusing process. The temperature and pressure were kept at about 55° C. and 1500 psi, respectively. The cycle time was about 2 hours. After the process was completed, the chamber was cooled down naturally and CO₂ was released to obtain resulting enhanced tequila composition A. The process was repeated using Extra Anejo tequila to obtain enhanced tequila composition AA. As shown in FIG. 3, composition A (Comp A) shows slight change of color from crystal clear of Plata tequila (Control 1) and has rich cannabis plant aromas and flavors. Composition AA is not shown.

### Example 4 Enhanced Tequila with Derivatives from Cannabis Plant and Oak Wood

100% agave tequila (Plata, distilled without aging) was obtained from a liquor store. About 0.05 g pre-treated cannabis plant flowers and 0.8 g pre-treated oak wood were soaked in about 50 ml Plata tequila in a supercritical CO₂ chamber which went through a supercritical enhancing and infusing process. The temperature and pressure were kept at about 55° C. and 1500 psi, respectively. The cycle time was about 2 hours. After the process was completed, the chamber was cooled down naturally and CO₂ was released to obtain resulting enhanced tequila composition B. The process was repeated using Extra Anejo tequila to obtain enhanced tequila composition BB. As shown in FIG. 3, composition B (Comp B) shows golden color which is richer than Reposado tequila (Control 3) and has both cannabis plant and oak wood aromas and flavors. The rich color was mainly the result of oak wood derived compounds as it is shown in comparison with Control 2 (oak wood only and without cannabis plant) in FIG. 3. Composition BB is not shown.

### Example 5 Enhanced Tequila with Derivatives from Cannabis Plant and Oak Wood—High Temperature

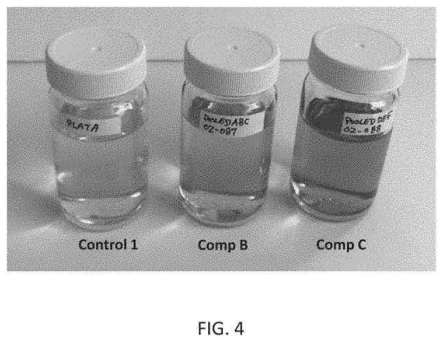

100% agave tequila (Plata, distilled without aging) was obtained from a liquor store. About 0.05 g pre-treated cannabis plant flowers and 0.8 g pre-treated oak wood were soaked in about 50 ml Plata tequila in a supercritical CO₂ chamber which went through a supercritical enhancing and infusing process. The temperature and pressure were kept at about 95° C. and 2200 psi, respectively. The cycle time was about 4 hours. After the process was completed, the chamber was cooled down naturally and CO₂ was released to obtain resulting enhanced tequila composition C. As shown in FIG. 4, composition C (Comp C) shows rich golden color which much richer than Comp B. The appearance was close to Extra Anejo tequila which has been aged in an oak wood barrel for 5 years.

The foregoing descriptions have been presented for purposes of illustration and description and are not intended to be exhaustive or to limit the invention to the precise form disclosed. The descriptions were selected to explain the principles of the invention and their practical application to enable others skilled in the art to utilize the invention in various embodiments and various modifications as are suited to the particular use contemplated. Although the invention has been described with reference to preferred embodiments, persons skilled in the art will recognize that changes may be made in form and detail without departing from the alcoholic beverage and scope of the invention.

The flowchart and block diagrams in the Figures illustrate the architecture, functionality, and operation of possible implementations of systems, and methods according to various embodiments of the present technology. It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. In the following description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments.

What is claimed is:

1. An enhanced alcoholic beverage composition comprising one or more cannabis plant derived compounds infused in an alcoholic beverage.

2. The composition of claim 1, wherein the cannabis plant derived compounds are cannabidiol (CBD), Δ⁹-tetrahydrocannabinol (THC) and/or terpenes.

3. The composition of claim 1, wherein the cannabis plant derived compounds have a ratio of 0.00001% to 5% (w/v %) of the alcoholic beverage.

4. The composition of claim 1, wherein the cannabis plant derived compounds have a ratio of 0.001% to 0.5% (w/v %) of the alcoholic beverage.

5. The composition of claim 1, wherein the enhanced alcoholic beverage composition is further comprising oak wood derived compounds in a ratio of 0.00005% to 5% (w/v %) of the alcoholic beverages.

6. The composition of claim 1, wherein the enhanced alcoholic beverage composition is further comprising oak wood derived compounds in a ratio of 0.005% to 0.5% (w/v %) of the alcoholic beverages.

7. The composition of claim 1, wherein the alcoholic beverage is a tequila, a whiskey, a scotch, a gin, a brandy, a vodka, a rum, a bourbon, a wine, and a beer.

8. The composition of claim 1, wherein the alcoholic beverage is an aged alcoholic beverage from tequila, whiskey, scotch, gin, brandy, vodka, rum, bourbon, wine, and beer.

9. The composition of claim 8, wherein the aged alcoholic beverage is aged from 1 day to 30 years in an oak wood barrel.

10. A method of enhanced alcoholic beverage infusion, the method comprising:
pretreat cannabis plant material; contacting pretreated cannabis plant material with alcoholic beverages in presence of
subcritical/critical/supercritical carbon dioxide thereby obtaining an enhanced alcoholic beverage composition.

11. A method of enhanced alcoholic beverage infusion, the method comprising:
pretreating cannabis plant material; pretreating of oak wood; contacting pretreated cannabis plant material and pretreated oak wood with alcoholic beverages in presence of subcritical/critical/supercritical carbon dioxide thereby obtaining an enhanced alcoholic beverage composition,

12. The method of claims 10 and 11, wherein the cannabis plant material is selected from the buds, flowers, the leaves, the stems, the stalks, the seeds, the roots or the combination of such.

13. The method of claims 10 and 11, wherein pretreating cannabis plant material is toasting or baking the cannabis plant materials at a temperature of about 100° C. to 300° C. for a time period of about 10 minutes to 6 hours.

14. The method of claim 13, wherein toasting or baking the cannabis plant materials is performed in an oxygen free environment.

15. The method of claim 11, wherein pretreating oak wood is toasting or baking the oak wood at a temperature of about 60° C. to 500° C. for a time period of about 5 minutes to 96 hours.

16. The method of claims 10 and 11, wherein contacting pretreated cannabis plant materials and/or oak wood with alcoholic beverages in presence of subcritical/critical/supercritical carbon dioxide comprising the step of soaking with alcoholic beverages in subcritical/critical/supercritical carbon dioxide for a period of time; returning the subcritical/critical/supercritical carbon dioxide to a non-subcritical/critical/supercritical state; and releasing carbon dioxide.

17. The method of claim 16, wherein during contacting step, the carbon dioxide is in subcritical/critical/supercritical status with a pressure from about 50 bar to 600 bar and a temperature about 20° C. to 150° C., and where in the period of contacting time is from about 5 minutes to 24 hours.

18. The method of claims 10 and 11, wherein during contacting step, the ratio (w/v) of pretreated cannabis plant to alcoholic beverage is from about 1:10 to about 1:10000.

19. The method of claim 11, wherein during contacting step, the ratio (w/v) of pretreated wood to alcoholic beverage is from about 1:10 to about 1:1000.

20. The method of claims 10 and 11, wherein contacting pretreated cannabis plant and/or oak wood with alcoholic beverages in presence of subcritical/critical/supercritical carbon dioxide is repeated one or more times.
